(19) United States
(12) Patent Application Publication
(10) Pub. No.: US 2002/0150857 A1
(43) Pub. Date: Oct. 17, 2002

(54) Orthodontic appliance

(75) Inventors: Masaaki Orikasa, Fukushima (JP); Mikio Mottate, Fukushima (JP); Harumi Mottate, Fukushima (JP); Charles J. Schultz, New York, NY (US)

Correspondence Address: SUGHRUE MION, PLLC, 2100 Pennsylvania Avenue, NW, Washington, DC, 20037-3213, US

(73) Assignee: TOMY INCORPORATED

(21) Appl. No.: 10/107,818

(22) Filed: Mar. 28, 2002

(30) Foreign Application Priority Data
Mar. 30, 2001 (JP) 2001-98448

(51) Int. Cl. A61C 3/00

(52) U.S. Cl. 433/8; 433/9

(57) ABSTRACT

An orthodontic appliance may easily be recognized by a sort and a tooth mark, and trace to confirm the history of material and the production process. The appliance has a production lot number indicated at the part thereof, and further, the sort and the tooth mark indicated at an easily recognizable place thereof.

### BACKGROUND OF THE INVENTION

1. Field of the Invention

The present invention relates to an orthodontic appliance, and more particularly relates to an orthodontic appliance such as an orthodontic bracket and a buccal tube.

2. Description of the Related Art

For an orthodontic treatment, it has been generally practiced to attach a small orthodontic appliance called as an orthodontic bracket or a buccal tube to patient's tooth. Namely, this kind of appliances are generally used by suitably fixing to the patient's teeth and applying external force to the misaligned teeth through an archwire bridged between the fixed orthodontic appliances.

A structure of the orthodontic bracket will be explained. The orthodontic bracket has a slot to be engaged with an archwire, and a main body to be directly adhered to a labial side or lingual side of the teeth, otherwise welded to a metal band which is attached to the teeth with band cement or other ways.

As a using embodiment of the thus formed orthodontic bracket, an elastic archwire formed into an arch shape corresponding to a patient's dental arch is mounted to the slot of the orthodontic bracket, and the teeth may be moved taking a long term of time owing to elastic recovery of the elastic archwire, so that the teeth alignment looks nice.

The orthodontic bracket can apply the force to the teeth in a desired direction (direction for sliding, rotation or tipping of the teeth) by a three-dimensional inclination of the slot formed at a bracket body or by an optional bend of the archwire.

The orthodontic appliances have specific shapes or structures in response to the teeth to be treated and there are a large variety of appliances. Therefore, in order to avoid misuse and correctly use the appliance, the orthodontic appliance has a discriminating indication of the tooth to which the orthodontic appliance is fixed and a mounting direction of the orthodontic appliance.

In related art, in the discriminating indication of the orthodontic bracket, a distal gingival side is shown by a V-notch or a paint so that V-notch or paint indicates the mounting direction of the orthodontic appliance or a position to which the orthodontic appliance is fixed.

The discriminating indication is represented , for example, by numerals, letters or special marks generally called as Palmer Notation.

However, in case a plurality of specifications (torque, angulation, offset) are used in combination, a discriminating indication is not made per each of the specifications, and a management has been left to persons in charge (orthodontist and staff).

To briefly explain about the discriminating indications, a most basic indication is originated from the Straight Wire Technique® in early 1980's.

In comparison with the orthodontic bracket of a symmetrical edgewise technique, the orthodontic bracket incorporated with torque, angulation, and offset (anti-rotation) is required to distinguish occluso-gingival sides.

The discriminating indication for distinguishing the occluso-gingival sides is in many cases employed in combination of mechanically processed permanent marks such as V-notches and dimples and temporary marks painted on the permanent marks.

When the doctor attaches the orthodontic bracket to the patient's tooth, a distinct indication such as paint is required for instantly distinguishing the upper and lower sides. The paint will disappear by brushing within the patient's mouth in about one month. However, a formative indication as a V-notch or a dimple remains for a long period of time and are effective, for example, in case the bracket falls off from the teeth and re-attaching is necessary.

Other important discriminating indication is that for indicating which tooth the orthodontic appliance is used at right or left sides of the upper and lower jaws.

Generally, the orthodontic appliances which are used to anterior teeth, cuspids and bicuspids are called as the orthodontic bracket (or briefly “bracket”) . The brackets are used for five to five teeth of the right and left and of the upper and lower jaws. Further, the orthodontic appliances which are used to the molars are called as a buccal tube. The related-art discriminating indications for showing required positions of the orthodontic appliance may be seen, for example, in the following publication.

A technology disclosed in the specification of U.S. Pat. No. 4,279, 593 proposes to give a tooth mark to a plastic cover for covering an orthodontic bracket. The plastic cover is removed after the orthodontic bracket is adhered to the tooth, but a problem involved therewith is that when the bracket is adhered to the tooth, the tooth marks are visually obstructive and the positioning of the bracket is difficult. Precisely, mesiodistal sides of the orthodontic bracket are put into agreement with an axis of a tooth crown while a slot (not seen because of presence of the cover) is put into parallel with an occulsal surface and the height of the slot is put into agreement with the maximum position (embrasure line) of a tooth width, but in this case, the slot cannot be seen.

Further, many doctors enter a probe (an explorer) into the slot to adjust the adhering position, and then have to press the bracket against a tooth surface for a certain period of time until an adhesive is hardened.

Therefore, the discriminating indication by way of the tooth mark indicated at the plastic cover has not been prevalent.

Inventor of the present invent ion proposed a technology for indicating a discriminating mark at an adhering surface of a bonding base of an orthodontic bracket as disclosed in the specification of U.S. Pat. No. 5,803,728. As a practical embodiment, convex or concave mark are engraved by a metal mold in the adhering surface of the bonding base of the plastic-made orthodontic bracket.

As to the indication at the adhering surface of the bonding base, an indicating area is large, and the mark is not outstanding if the adhering surface is attached to the tooth surface with an adhesive. Further, the mark is not visually obstructive when positioning the bracket at the adhering surface.

Further, a technology disclosed in European Patent Application EP0876801A1 discloses method for indicating the tooth mark by way of a laser marking on adhering surface of the bonding base. The merit of this method is that the mark may be clearly recognized because the mark is formed by laser marking at the adhering surface having a metal mesh of the bonding base so that the mark is oxidized in black.

As to the related art orthodontic appliances, the specifications are different in dependence upon treating methods of doctors and clinical cases.

The doctors' treating method is represented by almost all of names of inventors, for example, Roth, Andrews, Ricketts®, Single Wing, Bidimentional, Planché, Hasund, Kosaka, or Roncone. With the types of the doctors' treating methods, although the orthodontic bracket is used, for example, to the same upper central teeth, the torque and angulation are different. It is, therefore, difficult to visually discriminate exterior views of the brackets.

Further, in case of selectively using, in one treating method, the orthodontic brackets of the specification for different clinical cases, the doctor has to pay careful attention to a correct use of the orthodontic brackets among the different types of brackets mixed in the doctor's chair side. Specifically, there are many cases of selectively using the orthodontic brackets of different specifications by the conditions of tooth extraction and non-extraction, the difference in class I, class II and class III, and the difference in features of face profiles and of dental arches. The different specifications are generally distinguished by changing the color of paint, by increasing the number of paint or by changing the indicating position of paint. However, such expedients are actually troublesome and are not always convenient for the doctors.

Generally, the orthodontic appliances are put into individual packs each containing 10 pieces of same ones and into a clinical case pack (or single patient kit) where there are arranged on a tray the pieces for 20 teeth (five to five, or 5-5) or 28 teeth (seven to seven, or 7-7) of the upper and lower and the right and left. The individual packs may be discriminated by a production lot number printed on the pack. However, the appliances which are sterilized or put into another vessel after they were taken out of the pack and used will not be traced to the production lot number unless the doctor specially makes a record.

As to the clinical case pack, the production lot number is given per kit, but each of products have different records. Moreover when forming the clinical case pack, it is troublesome to make records of the production lot numbers of each of the products. Some suppliers indicate the production lot numbers of each of the products at the rear side of the wrapping boxes of clinical case pack.

However, notwithstanding this, so far as the production lot numbers are not transferred to the carte that is used by the doctor, raw materials and production histories of the products cannot be traced when required.

### SUMMARY OF THE INVENTION

The invention has been provided to solve the problems as mentioned above, and accordingly it is an object of the invention to provide a orthodontic appliance not only easy to discriminate sorts or tooth marks, but also able to trace the production histories.

In order to accomplish the object above, the following means are adopted. According to the present invention, there is provided an orthodontic appliance having a production lot number indicated at a part thereof. Incidentally, “the production lot number” is a mode of indication which shows at least the time when the product has been produced or shipped.

In this way, with the production lot number indicated at a part of the orthodontic appliance, it is possible to trace the product as to how many the products are, when, through which process and with what raw materials the products have been produced. Thereby, in case it happens later that the product has to be collected on account of a problem about raw materials or a process, the production lot number enables to rapidly cope with the problem.

The orthodontic appliance further may have a tooth mark indicated at the part thereof. Incidentally, the “tooth mark” is a combination of a sign showing a name of a tooth and a sign showing a position of the right and left sides of the upper and lower jaws.

In this way, with the production lot number and the tooth mark indicated at a part of the orthodontic appliance, not only it is possible to trace the products as to when, through which process and with what raw materials the products have been produced, but also the appliance is prevented from being misused at the time of treatment.

The orthodontic appliance preferably comprises a bonding base to be fixedly attached to a tooth face, the bonding base having the production lot number and or tooth mark indicated at a base surface thereof. In this way, with the production lot number and the tooth mark indicated at the base surface of the bonding base of the orthodontic appliance, the indication area is large for easy confirmation, and it is possible to trace the products as to when, through which process and with what raw materials the products have been produced, and the appliance is prevented from being misused at the time of treatment.

Further, the orthodontic appliance preferably comprises a bonding base to be fixedly attached to a tooth face, the bonding base having a tooth mark and a sort indicated at a base surface thereof. Incidentally, the “sort” is a sort different in a form of the bracket, a sort different in a size of the slot, a sort different in the treating method of the doctor, a sort different in the torque, angulation or offset, a sort different in the clinical case to which the appliance is used, or a sort different in the specification by the face profiles and of the dental arch.

In this way, with the tooth mark and the sort indicated on the base surface of the bonding base of the orthodontic appliance, the indication area is large so that much information may be indicated and easily confirmed, and further, the appliance is prevented from being misused at treatment.

The bonding base may have the production lot number, tooth mark and sort indicated at the base surface thereof.

In this way, with the production lot number, the tooth mark and the sort indicated at the base surface of the bonding base of the orthodontic appliance, the indication area is large so that much information may be indicated and easily confirmed, and it is possible to trace the products as to when, through which process and with what raw materials the products have been produced, and the appliance is prevented from being misused at the time of treatment.

In the orthodontic appliance, the sort is preferably indicated by one or more of alphabet letters. Therefore, the sort may be easily discriminated.

In the orthodontic appliance, the production lot number is preferably indicated by means of laser marking. Therefore, the indications will be free of the influence of the material of the part to be marked and simple and exact indications may be obtained.

In the orthodontic appliance, the production lot number may be indicated by means of electrolytic chemical etching. Therefore, the indications will be free of the influence of unevenness of the part to be marked.

In the orthodontic appliance, the production lot number is preferably indicated by means of ink-jet printing. Therefore, the indications will be free of the influence of the material of the part to be marked and of a base curvature, and the indications may be very easily obtained.

In the orthodontic appliance, the production lot number may be indicated by the dot mark. Therefore, the indication may be simple instead of using a complicated mark. Moreover, the indication may be easily confirmed in a limited space which is efficiently used.

Further, in the orthodontic appliance, the production lot number is preferably indicated so that white and black, or light and darkness are distinguished between the production lot number and the background thereof. Therefore, the same marks or numerals may be used for different information and in much quantity. Further, the indication may be made easy to see in response to requirement.

### BRIEF DESCRIPTION OF THE DRAWINGS

FIG. 1A is a plan view of an orthodontic bracket of a first embodiment of the invention;

FIG. 1B is a side view of the orthodontic bracket of the first embodiment of the invention;

FIG. 2 is a plan view of an adhering surface of a bonding base of the first embodiment of the invention;

FIG. 3 is a plan view of the adhering surface of the bonding base of the first embodiment of the invention;

FIG. 4 is a plan view of the adhering surface of the bonding base of the first embodiment of the invention;

FIG. 5 is a plan view of the adhering surface of the bonding base of the first embodiment of the invention;

FIG. 6 is a plan view of the adhering surface of the bonding base of the first embodiment of the invention;

FIG. 7 is a plan view of the adhering surface of the bonding base of the first embodiment of the invention;

FIG. 8 is a plan view of the adhering surface of the bonding base of the first embodiment of the invention;

FIG. 9 is a plan view of an adhering surface of a bonding base of a second embodiment of the invention;

FIG. 10 is a plan view of the adhering surface of the bonding base of the second embodiment of the invention;

FIG. 11 is a plan view of the adhering surface of the bonding base of the second embodiment of the invention;

FIG. 12 is a plan view of the adhering surface of the bonding base of the second embodiment of the invention;

FIG. 13 is a plan view of the adhering surface of the bonding base of the second embodiment of the invention;

FIG. 14 is a plan view of the adhering surface of the bonding base of the second embodiment of the invention;

FIG. 15 is an explanatory view showing an indication mode of an adhering surface of a bonding base of a third embodiment of the invention;

FIG. 16 is an explanatory view showing the indication mode of the adhering surface of the bonding base of the third embodiment of the invention; and

FIG. 17 is an explanatory view showing the adhering surface of the bonding base of the third embodiment of the invention.

### DETAILED DESCRIPTION OF THE INVENTION

An orthodontic bracket as an embodiment of the orthodontic appliance of the invention will be described below in detail in reference to the attached drawings.

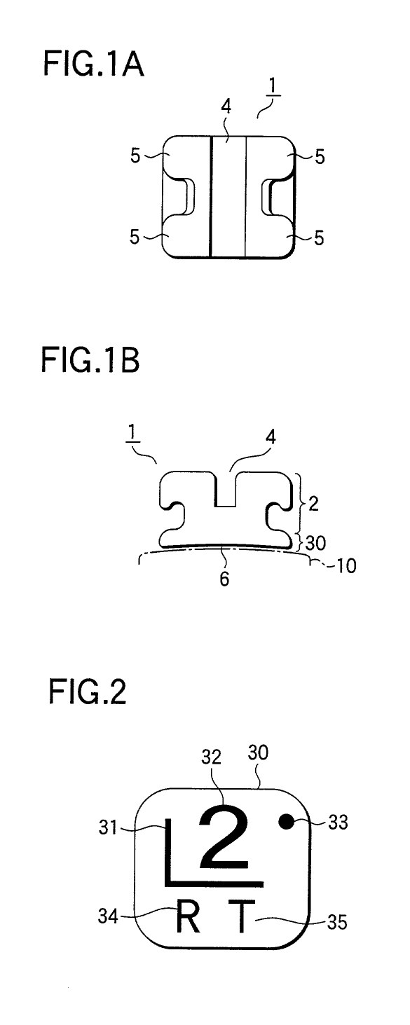

FIG. 1 shows the orthodontic bracket as a first embodiment of the invention, in which A is a plan view of the bracket and B is a side view of the bracket;

FIGS. 2 through 8 are plan views of a base surface of a bonding base (an adhering surface of a rear side) of the first embodiment of the invention;

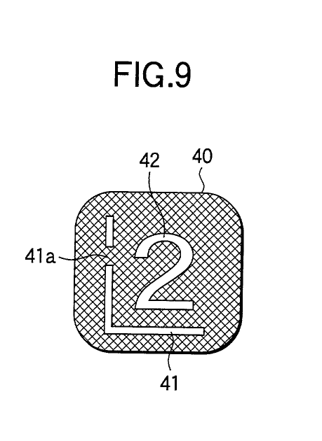

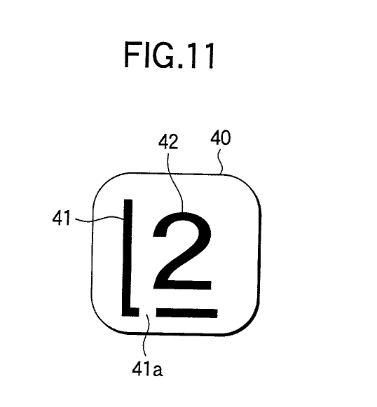

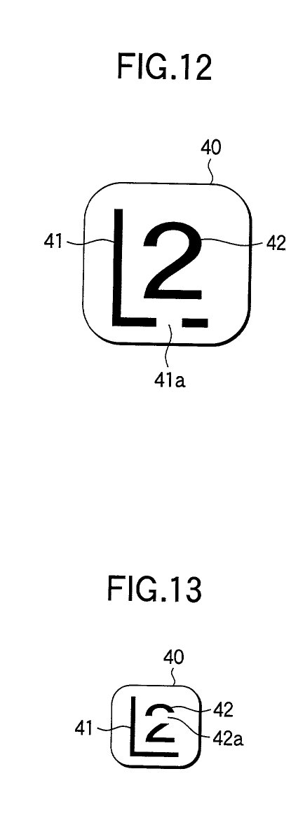

FIGS. 9 through 14 are plan views of a base surface of a bonding base (an adhering surface) of a second embodiment of the invention; and

FIGS. 15, 16 and 17 are explanatory views showing a base surface (an adhering surface) of a bonding base and indication modes as a third embodiment of the invention.

(A First Embodiment)

The orthodontic bracket as shown in FIG. 1 has mesiodistal side tie-wings 5, a bonding base 30, a bracket body 2 and an archwire slot 4. The bonding base 30 has an adhering surface 6 (a rear side of a base surface) to be fixed to a tooth face 10. The bracket body 2 extends generally in vertical direction from the bonding base 30. The archwire slot 4 is formed generally at a center of the bracket body 2 and extends in the mesiodistal directions.

Incidentally, FIGS. 2 through 14 show the embodiments of the adhering surfaces of the bonding base which may be applied to the orthodontic bracket 1 shown in FIG. 1, the buccal tube and to others.

In the embodiments as shown in FIGS. 2 through 14, the adhering surface of the base surface of the bonding base 30 has a tooth mark, a sort and a lot number indicated by means of a laser marking, an electrolytic chemical etching, or an ink-jet printing.

Incidentally, the marks will be explained for the teeth, the names and the positions thereof. As to the marks for the names, permanent teeth are indicated with Arabic numerals, deciduous teeth are indicated with Roman numerals or alphabets of small letter. In this case, as going from the mid-position of the teeth toward the distal direction, the numeral is indicated as moving up or advancing (this method is called as “Palmer Notation). Further, the positions of tooth, that is, the upper and lower jaws and the right and left sides are indicated with a quadrant crossing a horizontal line with a vertical line normal to the horizontal line. The horizontal line indicates a border between the upper and lower jaws and the vertical line indicates the borders between the left and right sides respectively, that is, the mid line.

In the embodiment, seeing the patient's dental arch from the front side, L-letter marks, for example, the right-side upper is indicated with “┘” and the right-side lower is indicated with “┐”. Further, in case “6” is indicated, for example, inside mark “┐”, this indicates the first molar at the right side of the lower jaw.

In FIG. 2, the adhering surface of the bonding base 30 is provided with indications such as an L-letter mark 31 (in the description, the L-letter marks such as “┌”, “┘”, “┐” which are differently oriented, are generally called as “L-letter mark” hereafter), a numeral mark 32, a dot mark 33 and alphabet marks 34, 35.

As to the meanings of the marks, the L-letter mark 31, for example, means the left side of the upper jaw. Since the numeral mark 32 is “2”, the mark means the second-positioned tooth, that is, the lateral incisor. Further, in case the alphabet mark 34 is “R” and the alphabet mark 35 is “T”, the “R” and “T” are taken from “ROTH” and indicate the ROTH specification. Further, the dot mark 33 is positioned uppermost at the right side, and in this case, the mark indicates the product as shipped in January.

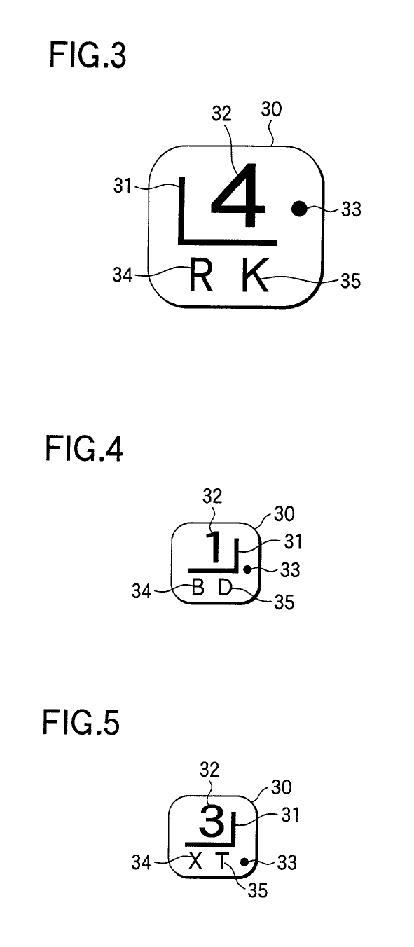

In addition, in FIG. 3, the adhering surface of the bonding base 30 is provided with the L-letter mark 31, the numeral mark 32, the dot mark 33 and the alphabet marks 34, 35.

The meanings of the respective marks are similar as indicated in FIG. 2. The L-letter mark 31 means the left side of the upper jaw. Since the numeral mark 32 is “4”, the mark means a fourth-positioned tooth, that is, the first premolar. Further, in case the alphabet mark 34 is “R” and the alphabet mark 35 is “K”, the “R” and “K” are taken from “RIKETTS” and indicate the RIKETTS® specification. Further, the dot mark 33 is positioned at the second stage below the uppermost stage at the right side. In this case, the mark indicates the product as shipped in February.

In addition, in FIG. 4, the adhering surface of the bonding base 30 is provided with the L-letter mark 31, the numeral mark 32, the dot mark 33 and the alphabet marks 34, 35.

As to the meanings of the respective marks, the L-letter mark 31 is laterally inverted at a vertical line portion differently from FIGS. 2 and 3, and this mark means the right side of the upper jaw. Since the numeral mark 32 is “1”, this mark means the first-positioned tooth, that is, the central incisor. Further, in case the alphabet mark 34 is “B” and the alphabet mark 35 is “D”, the “B” and “D” are taken from “Bidimentional” and indicate the Bidimentional specification. Further, the dot mark 33 is positioned at the third stage below the uppermost position at the right side. In this case, the mark indicates the product as shipped in March.

In addition, in FIG. 5, the adhering surface of the bonding base 30 is provided with the L-letter mark 31, the numeral mark 32, the dot mark 33 and the alphabet marks 34, 35.

The meanings of the respective marks are the same as FIG. 4. The L-letter mark 31 means the right side of the upper jaw. Since the numeral mark 32 is “3”, this mark means the third-positioned tooth, that is, the cuspid. Further, in case the alphabet mark 34 is “X” and the alphabet mark 35 is “T”, the “X” and “T” are taken from “Extra Torque” and indicate the Extra Torque specification. Further, the dot mark 33 is positioned at the lowermost stage of the right side, that is, at the fourth stage below the uppermost position. In this case, the mark indicates the product as shipped in April.

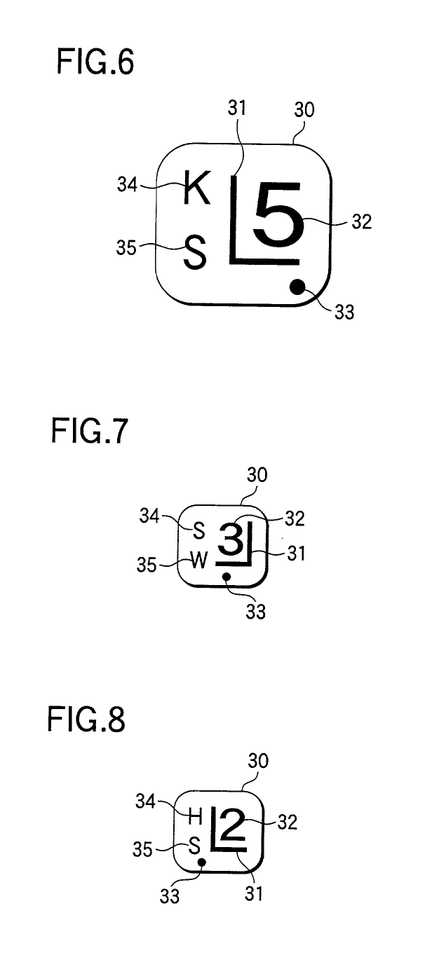

In addition, in FIG. 6, the adhering surface of the bonding base 30 is provided with the L-letter mark 31, the numeral mark 32, the dot mark 33 and the alphabet marks 34, 35.

As to the meanings of the respective marks, the L-letter mark 31 means the left side of the upper jaw. Since the numeral mark 32 is “5”, this mark means the fifth-positioned tooth, that is, the second bicuspid. Further, in case the alphabet mark 34 is “K” and the alphabet mark 35 is “S”, the “K” and “S” are taken from “KOSAKA” and indicate the KOSAKA OPAK® specification. Further, the dot mark 33 is positioned at the lowermost stage at the second file from the right side. In this case, the mark is regarded as the fifth and indicates the product as shipped in May.

Also, in FIG. 7, the adhering surface of the bonding base 30 is provided with the L-letter mark 31, the numeral mark 32, the dot mark 33 and the alphabet marks 34, 35.

As to the meanings of the respective marks, the L-letter mark 31 means the right side of the upper jaw. Since the numeral mark 32 is“3”, this mark means the third-positioned tooth, that is, the cuspid. Further, in case the alphabet mark 34 is “S” and the alphabet mark 35 is “W”, the “S” and“W” are taken from“Single Wing” and indicate the Single Wing specification. Further, the dot mark 33 is positioned at the lowermost stage at the third file from the right side. In this case, the mark is regarded as the sixth and indicates the product as shipped in June.

Also, in FIG. 8, the adhering surface of the bonding base 30 is provided with the L-letter mark 31, the numeral mark 32, the dot mark 33 and the alphabet marks 34, 35.

As to the meanings of the respective marks, the L-letter mark 31 means the left side of the upper jaw. Since the numeral mark 32 is “2”, this mark means the second-positioned tooth, that is, the lateral incisor. Further, in case the alphabet mark 34 is “H” and the alphabet mark 35 is “S”, the “H” and “S” are taken from “Hasund” and indicate the Hasund specification. Further, the dot mark 33 is positioned at the lowermost stage at the fourth file from the right side. In this case, the mark is regarded as the seventh and indicates the product as shipped in July.

In the embodiments shown in FIGS. 2 through 8, among the tooth marks, the vertical line portion of the L-letter mark means the center line, and the horizontal line portion means the border between the upper and lower jaws. Namely, the horizontal line portion of the L-letter mark is determined to indicate an occulsal surface and is determined to attach the appliance to the upper side or the lower side.

Therefore, the mark “┘” of the tooth marks indicates that the appliance is attached to the right-side upper of the teeth of the patient, seeing the front side of the patient. On the other hand, the mark “└” indicates the left-side upper. The mark “┐” indicates the right-side lower and the mark “┌” indicates the left-side lower.

(A Second Embodiment)

The indications as shown in FIGS. 9 through 14 are formed in a bonding base 40 and indicate the second tooth at the left side of the upper jaw, that is, the lateral incisor. In FIGS. 9, 10, 11 and 12, among the tooth marks, an L-letter mark 41 has a cutout 41a formed at a part thereof. The cutout 41a is formed at a specific position to indicate a month when the appliance was produced, so as to be referred to a production lot number.

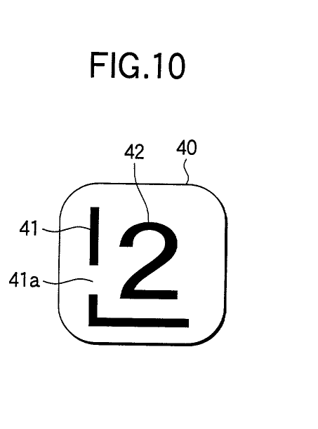

Incidentally, as to the indications as shown in FIG. 9, the indication contents (the L-letter mark 41, the cutout 41a, and the numeral mark 42) and the indicating surface (the adhering surface) of the bonding base 40 at which the indication contents are formed have black and white or light and darkness inverted differently from those shown in FIGS. 10 through 14.

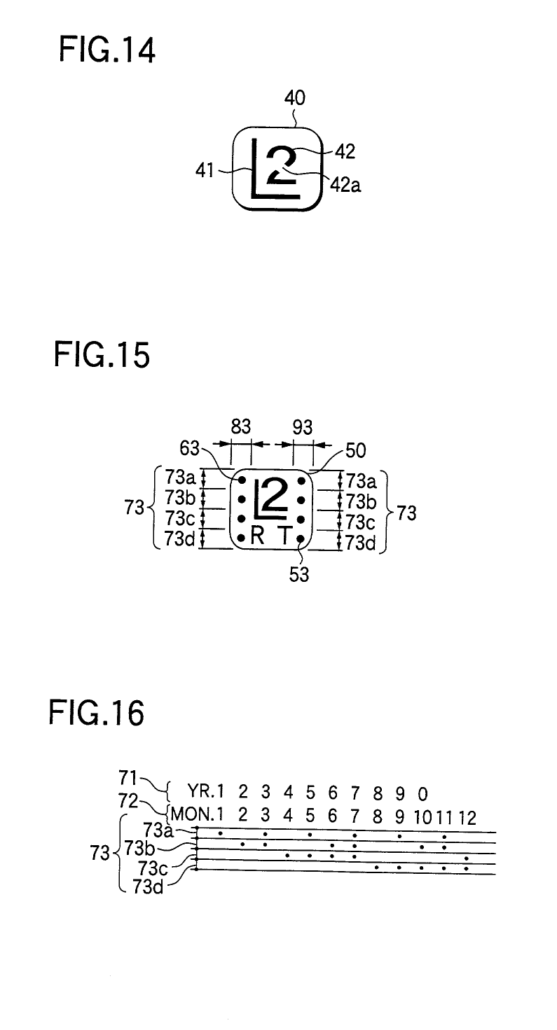

In FIGS. 13 and 14, among the tooth marks, the numeral mark 42 has a cutout 42a formed at a part thereof. The cutout 42a is formed at a specific position to indicate a month when the appliance was produced, so as to be referred to a production lot number.

Incidentally, it is possible to put into combination the numeral mark 42 and the L-letter mark 41, having the cutouts 42a and 41a formed at the parts thereof respectively.

Further, the black and white or the light and darkness may be inverted as shown in FIG. 9. Further, a certification mark, and a discrimination code of a certifying organization may be indicated together.

(A Third Embodiment)

The invention may employ the indicating modes as shown in FIGS. 15, 16 and 17.

In FIG. 15, the discriminating indications at the adhering surface of a bonding base 50 include a binary cede forming area 83 showing dot marks 63 for indicating a production year (in the Figures, the area in which the dot marks 63 are arranged in the vertical direction at the left side of the bonding base 50) and another binary code forming area 93 showing the dot marks for indicating a production month at the right side (in the Figure, the area in which dot marks 53 are arranged in the vertical direction at the right side of the bonding base 50), thereby to indicate the production year and month (corresponding to the lot number).

In this case, between the dot marks 53 and 63, there are provided the discriminating indications as shown in FIG. 2 of the first embodiment.

FIG. 16 shows an explanatory view for the meanings of the dot marks 53,63.

In FIG. 16, the portion of upper most line 71 shows years and the second line 72 shows months. In parallel to the lines of years and months, there are shown four-stepped (73a, 73b, 73c, 73d) dot corresponding lines 73. As to the dot corresponding lines 73, the upper most step 73a shows 1, the second lower step 73b shows 2, the third lower step 73c shows 4 and the fourth lower step 73d shows 8.

Accordingly, in case of showing the year of 2001 or January (the year is the last figure of the Christian Era), the dot mark 53 or 63 is formed at the uppermost step. In case of showing the year 2002 or February, the dot mark 53 or 63 is formed at the second lower step. In case of showing the year 2003 or March, the dot mark 53 or 63 is formed at the two places of the uppermost step and the second step.

Namely, the indication showing the year 2003 or March is made by addition (binary indication) of the dot meaning “1” and the dot meaning “2”. The numerical values more than “4” may be indicated by the same manner.

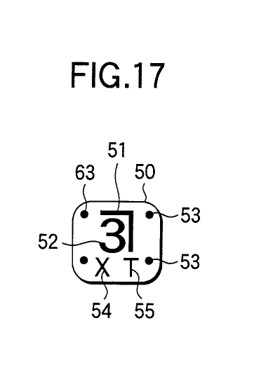

The bracket having the adhering surface of bonding base 50 as shown in FIG. 17 is indicated to be the extra torque bracket of the third at the right side of the lower jaw by way of a L-letter mark 51, a numeral mark 52 and alphabet marks 54, 55. Further, this bracket is indicated to have been produced in May of 2001 by the dot marks 53 and 63.

In the foregoing embodiments, the explanation has been made only about the orthodontic bracket, it is of course that the invention may be applied to the buccal tube and other various orthodontic appliances for correcting irregularities of the teeth.

What is claimed is:

1. An orthodontic appliance having a production lot number indicated at a part thereof.

2. The orthodontic appliance according to claim 1, further having a tooth mark indicated at the part thereof.

3. The orthodontic appliance according to claim 1, wherein said orthodontic appliance comprises a bonding base to be fixedly attached to a tooth face, the bonding base having the production lot number indicated at a base surface thereof.

4. The orthodontic appliance according to claim 2, wherein said orthodontic appliance comprises a bonding base to be fixedly attached to a tooth face, the bonding base having the production lot number and the tooth mark indicated at a base surface thereof.

5. The orthodontic appliance according to claim 3, wherein the bonding base further has a sort indicated at the base surface thereof.

6. The orthodontic appliance according to claim 4, wherein the bonding base further has a sort indicated at the base surface thereof.

7. An orthodontic appliance comprising:
a bonding base to be fixedly attached to a tooth face, the bonding base having a tooth mark and a sort indicated at a base surface thereof.

8. The orthodontic appliance according to claim 5, wherein the sort is indicated with one or more of alphabet letters.

9. The orthodontic appliance according to claim 6, wherein the sort is indicated with one or more of alphabet letters.

10. The orthodontic appliance according to claim 7, wherein the sort is indicated with one or more of alphabet letters.

11. The orthodontic appliance according to claim 1, wherein the production lot number is indicated by a laser marking.

12. The orthodontic appliance according to claim 1, wherein the production lot number is indicated by an electrolytic chemical etching.

13.The orthodontic appliance according to claim 1, wherein the production lot number is indicated by an ink-jet printing.

14.The orthodontic appliance according to claim 1, wherein the production lot number is indicated by a dot mark.

15.The orthodontic appliance according to claim 1, wherein the production lot number is indicated so that white and black, or light and darkness are distinguished between the production lot number and a back ground thereof.
